(19) United States
(12) Patent Application Publication
(10) Pub. No.: US 2026/0146928 A1
(43) Pub. Date: May 28, 2026

(54) SYSTEM AND METHOD FOR ENGINEERING GEOMECHANICAL EXPERIMENTAL TESTING OF RESERVOIR ROCK MASS

(71) Applicant: INSTITUTE OF GEOLOGY AND GEOPHYSICS, CAS, Beijing (CN)

(72) Inventors: Shengwen QI, Beijing (CN); Bowen ZHENG, Beijing (CN); Wenjie HAO, Beijing (CN); Wang ZHANG, Beijing (CN); Bo WAN, Beijing (CN); Wei LU, Beijing (CN); Xiaokun HOU, Beijing (CN); Guangming LUO, Beijing (CN); Lina MA, Beijing (CN); Yongchao LI, Beijing (CN); Zan WANG, Beijing (CN); Weiwei ZHU, Beijing (CN); Jianing CONG, Beijing (CN); Guoliang LI, Beijing (CN); Yuran ZHANG, Beijing (CN); Songfeng GUO, Beijing (CN); Yu ZOU, Beijing (CN); Chao JIN, Beijing (CN); Ning LIANG, Beijing (CN); Xin YU, Beijing (CN)

(73) Assignee: INSTITUTE OF GEOLOGY AND GEOPHYSICS, CAS, Beijing (CN)

(21) Appl. No.: 19/392,728

(22) Filed: Nov. 18, 2025

(30) Foreign Application Priority Data
Nov. 28, 2024 (CN) 202411718746.6

(51) Int. Cl. G01N 3/18; G01N 3/04; G01N 3/12

(52) U.S. Cl. CPC G01N 3/18; G01N 3/04; G01N 3/12

(57) ABSTRACT

Provided is a system for engineering geomechanical experimental testing of a reservoir rock mass, including a stress control unit, a temperature control unit and a rock sample holder. The stress control unit includes a rigid pressure-applying mechanism and a flexible pressure-applying mechanism. The rigid pressure-applying mechanism is configured to apply rigid pressure to a rock mass via an indenter and a pressing piece. The flexible pressure-applying mechanism is configured to apply flexible pressure to the rock mass by using a pressure medium. Rigid pressure application and flexible pressure application are integrated to simulate a stress status under an actual geological condition better, and uniformity of pressure application is also ensured. The temperature control unit is configured to control a temperature of the rock mass via a heating mechanism and a cooling mechanism. A method for engineering geomechanical experimental testing of a reservoir rock mass is further provided.

### CROSS REFERENCE TO RELATED APPLICATION

This patent application claims the benefit and priority of Chinese Patent Application No. 202411718746.6, filed with the China National Intellectual Property Administration on Nov. 28, 2024, the disclosure of which is incorporated by reference herein in its entirety as part of the present application.

### TECHNICAL FIELD

The present disclosure relates to the field of engineering geomechanical experimental testing of a reservoir rock mass, and in particular, relates to a system and a method for engineering geomechanical experimental testing of a reservoir rock mass.

### BACKGROUND

For reservoir geological engineering applications such as carbon dioxide geological utilization and storage, deep and ultra-deep oil and gas development, geothermal exploitation, and nuclear waste geological disposal, rock masses undergo long-term, complex physical, chemical, and mechanical responses in multiphase multifield coupling environments. This specifically involves mechanical properties of rock masses under extreme environments encountered in high-temperature, high-pressure, high-permeability, and long-cycle testing including temperatures up to 500° C., confining pressure up to 200 MPa, seepage pressure up to 200 MPa, and loading cycles of six months. It is revealed that the evolution of pores/fractures, long-term deformation, damage degradation, and progressive failure mechanisms in rock masses under coupling conditions of high geothermal temperature, in-situ stress, and seepage pressure is essential for advancing the understanding of engineering geomechanical properties of reservoir rock masses and enabling intelligent site characterization for deep geological engineering projects.

Current technical means for engineering geomechanical experimental testing of reservoir rock masses are primarily focused on testing of mechanical behaviors of rock masses under multiphase multifield-coupled true triaxial loading conditions at temperatures below 300° C., confining pressures below 100 MPa, and seepage pressure below 100 MPa. For more complex testing environments, existing technological reserves have only reported relevant achievements under specific extreme conditions, but cannot effectively meet stringent requirements for temperature control at a high temperature, sealing control under high pressure and high seepage pressure, and long-term stable loading control during testing.

### SUMMARY

An objective of the present disclosure is to provide a system for engineering geomechanical experimental testing of a reservoir rock mass, to resolve the problem in the conventional technology, meet an engineering geomechanical experimental testing need of the reservoir rock mass, and ensure smooth testing.

To achieve the above objective, the present disclosure provides the following technical solutions.

The present disclosure provides a system for engineering geomechanical experimental testing of a reservoir rock mass, including:
a stress control unit, where the stress control unit includes a rigid pressure-applying mechanism and a flexible pressure-applying mechanism, the rigid pressure-applying mechanism includes a pressing piece and an indenter, the pressing piece is pressed against a rock mass, the indenter is connected to the pressing piece, and the indenter is connected to a loading driver; there are six rigid pressure-applying mechanisms, and the six rigid pressure-applying mechanisms enclose a cuboid structure, and are disposed around the rock mass to apply true triaxial stress to the rock mass; and the flexible pressure-applying mechanism includes a pressure-applying cavity, where the pressure-applying cavity is connected to an external pressurized medium source, and the external pressurized medium source is configured to convey a pressure medium into the pressure-applying cavity, to apply flexible pressure to the rock mass;
a temperature control unit, where the temperature control unit includes a thermal insulation mechanism, a heating mechanism, and a cooling mechanism, the thermal insulation mechanism includes an inner insulation sleeve and an outer insulation sleeve, the inner insulation sleeve is disposed outside the rock mass, the pressing piece extends through the inner insulation sleeve to press against the rock mass; and the outer insulation sleeve is disposed outside the inner insulation sleeve and the pressing piece, and the indenter extends through the outer insulation sleeve and is connected to the pressing piece; the heating mechanism is configured to heat the rock mass; and the cooling mechanism is configured to cool the rock mass; and
a rock sample holder, where the rock sample holder is of a split-type structure, the rock sample holder is disposed outside the outer insulation sleeve to fasten the stress control unit and the temperature control unit, and a space between the rock sample holder and the pressing piece defines the pressure-applying cavity.

Preferably, the loading driver is a hydraulic oil cylinder, the loading driver is connected to a servo-hydraulic module, the servo-hydraulic module includes a motor, an oil pump, and a hydraulic oil tank, an output end of the motor is in transmission connection to the oil pump, the motor is configured to drive the oil pump to rotate, the oil pump is connected to the hydraulic oil tank, the oil pump is connected to the loading driver through a main oil line, the main oil line is further connected to a pilot line, and a pressure difference balance valve is disposed on the pilot line.

Preferably, the pressure medium is silicone oil.

Preferably, the heating mechanism includes a heating plate, the heating plate is disposed in the inner insulation sleeve and adjacent to the pressing piece, and the heating plate is configured to heat the pressure medium and the pressing piece to heat up the rock mass.

Preferably, the heating plate has a comb-shaped structure.

Preferably, the cooling mechanism includes cooling channels, the cooling channels are disposed inside and outside the rock sample holder, the cooling channel is connected to an external cooling medium source, and the external cooling medium source is configured to convey a cooling medium to the cooling channel, to cool the rock mass.

Preferably, a sealing frame is sleeved outside the rock mass, the sealing frame is of a rectangular frame structure, and the pressing piece is pressed against the sealing frame to seal the rock mass in space enclosed by the pressing piece; and

a testing channel is provided in each of the pressing piece and the indenter to receive a test probe, a sealing ring is disposed in the testing channel, and a locating pin is disposed between the indenter and the pressing piece.

Preferably, the system for engineering geomechanical experimental testing of a reservoir rock mass further includes a multi-phase fluid control unit, where the multi-phase fluid control unit includes an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; and the multi-phase fluid channel is disposed in the pressing piece, the multi-phase fluid channel is a T-shaped channel, the multi-phase fluid channel includes an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

Preferably, the system for engineering geomechanical experimental testing of a reservoir rock mass further includes a digital control unit, where the stress control unit, the temperature control unit, and the multi-phase fluid control unit are all in communication connection to the digital control unit.

The present disclosure further provides a system for engineering geomechanical experimental testing of a reservoir rock mass, using the system for engineering geomechanical experimental testing of a reservoir rock mass and comprising the following steps:
placing a rock mass in space enclosed by the six rigid pressure-applying mechanisms, applying rigid pressure, by the loading driver, to the rock mass via the indenter and the pressing piece, and applying, by the flexible pressure-applying mechanism, flexible pressure to the rock mass by using a pressure medium; and
adjusting a temperature, by the temperature control unit, via the heating mechanism and the cooling mechanism, to make the rock mass reach a testing temperature condition, where the thermal insulation mechanism is configured to provide thermal insulation for the rock mass.

Compared with the conventional technology, the present disclosure provides the following technical effects. The system for engineering geomechanical experimental testing of a reservoir rock mass includes the stress control unit, the temperature control unit, and the rock sample holder. The stress control unit includes the rigid pressure-applying mechanism and the flexible pressure-applying mechanism, the rigid pressure-applying mechanism includes the pressing piece and the indenter, the pressing piece is pressed against the rock mass, the indenter is connected to the pressing piece, and the indenter is connected to the loading driver. There are six rigid pressure-applying mechanisms, the six rigid pressure-applying mechanisms enclose the cuboid structure, and are disposed around the rock mass to apply true triaxial stress to the rock mass. The flexible pressure-applying mechanism includes the pressure-applying cavity, where the pressure-applying cavity is connected to the external pressurized medium source, and the external pressurized medium source is configured to convey a pressure medium into the pressure-applying cavity, to apply flexible pressure to the rock mass. The temperature control unit includes the thermal insulation mechanism, the heating mechanism, and the cooling mechanism. The thermal insulation mechanism includes an inner insulation sleeve and an outer insulation sleeve, the inner insulation sleeve is disposed outside the rock mass, and the pressing piece extends through the inner insulation sleeve to abut against the rock mass. The outer insulation sleeve is disposed outside the inner insulation sleeve and the pressing piece, and the indenter extends through the outer insulation sleeve and is connected to the pressing piece. The heating mechanism is configured to heat the rock mass. The cooling mechanism is configured to cool the rock mass. The rock sample holder is of a split-type structure, the rock sample holder is disposed outside the outer insulation sleeve to fasten the stress control unit and the temperature control unit, and a space between the rock sample holder and the pressing piece defines the pressure-applying cavity.

According to the system for engineering geomechanical experimental testing of a reservoir rock mass provided in the present disclosure, the stress control unit includes the rigid pressure-applying mechanism and the flexible pressure-applying mechanism. The rigid pressure-applying mechanism is configured to apply rigid pressure to the rock mass via the indenter and the pressing piece. The flexible pressure-applying mechanism is configured to apply flexible pressure to the rock mass by using the pressure medium. Rigid pressure application and flexible pressure application are integrated in the present disclosure to simulate a stress status under an actual geological condition better, and uniformity of pressure application is also ensured. The temperature control unit is configured to control the temperature of the rock mass via the heating mechanism and the cooling mechanism. In addition, the thermal insulation mechanism is configured to provide double-layer thermal insulation via the inner insulation sleeve and the outer insulation sleeve. In this way, a testing temperature condition for the rock mass is achieved and kept, and guarantee is provided for testing.

The present disclosure further provides a method for engineering geomechanical experimental testing of a reservoir rock mass, using the system for engineering geomechanical experimental testing of a reservoir rock mass.

### BRIEF DESCRIPTION OF THE DRAWINGS

To describe the technical solutions in embodiments of the present disclosure or in the conventional technology more clearly, the accompanying drawings required for the embodiments are briefly described below. Apparently, the accompanying drawings in the following description show merely some embodiments of the present disclosure, and a person of ordinary skill in the art may still derive other accompanying drawings from these accompanying drawings without creative efforts.

FIG. 1 is a front schematic diagram of a system for engineering geomechanical experimental testing of a reservoir rock mass disclosed in an embodiment of the present disclosure;

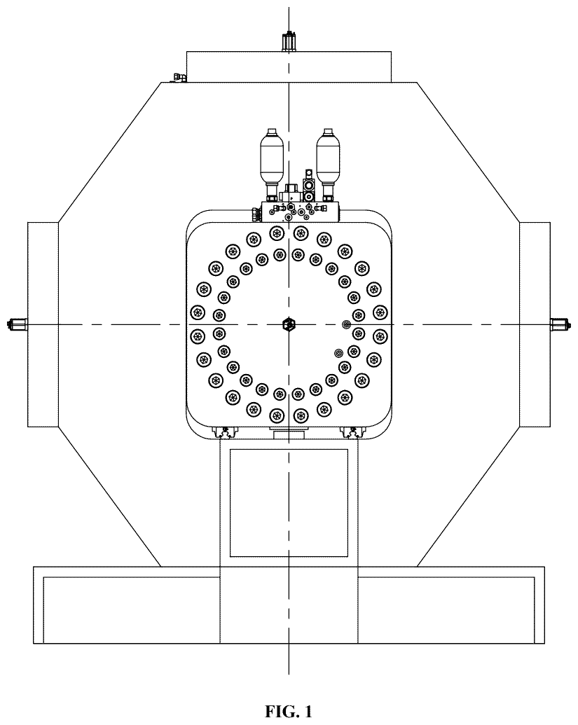

FIG. 2 is a side schematic diagram of a system for engineering geomechanical experimental testing of a reservoir rock mass disclosed in an embodiment of the present disclosure;

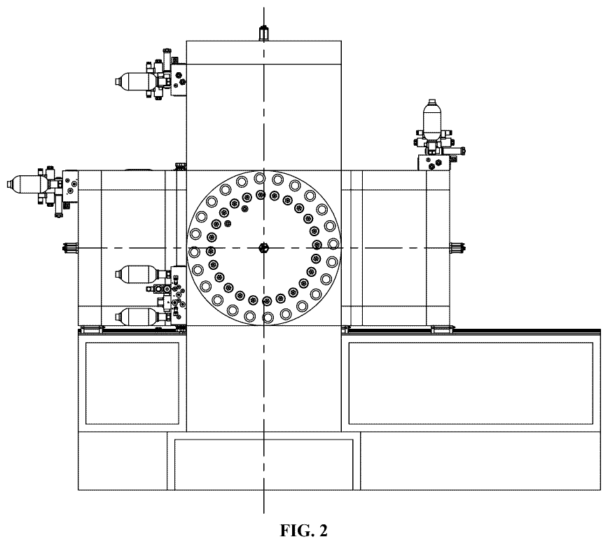

FIG. 3 is a partial cut-way schematic diagram of a system for engineering geomechanical experimental testing of a reservoir rock mass disclosed in an embodiment of the present disclosure;

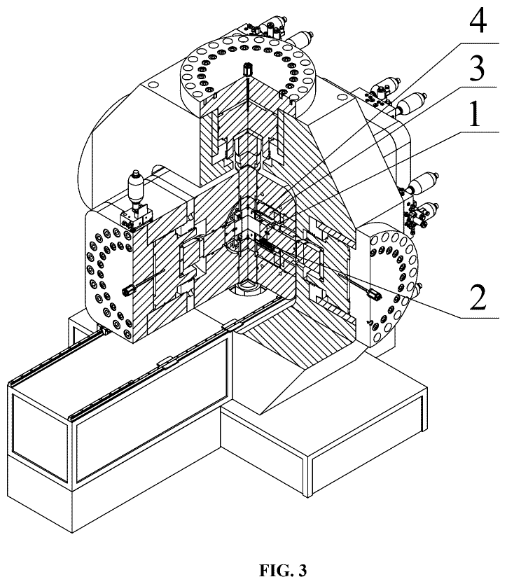

FIG. 4 is a schematic diagram of a servo-hydraulic module of a system for engineering geomechanical experimental testing of a reservoir rock mass disclosed in an embodiment of the present disclosure;

FIG. 5 is a schematic diagram of a partial structure of a digital control unit of a system for engineering geomechanical experimental testing of a reservoir rock mass disclosed in an embodiment of the present disclosure;

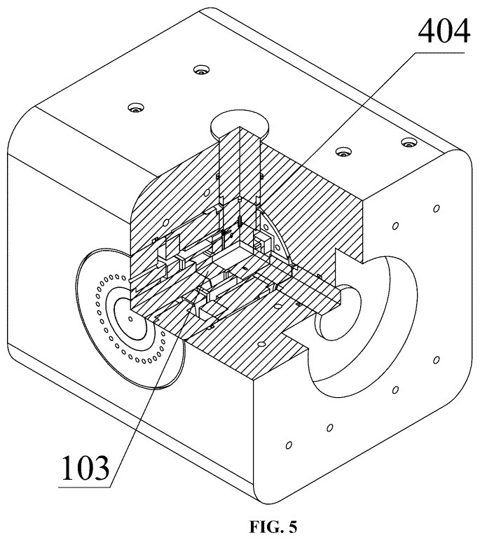

FIG. 6 is a cross-sectional view of a digital control unit of a system for engineering geomechanical experimental testing of a reservoir rock mass disclosed in an embodiment of the present disclosure;

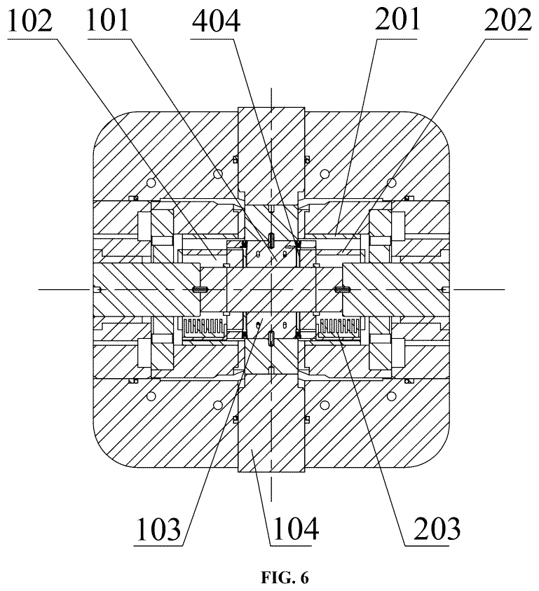

FIG. 7 is a schematic diagram of a cut-way structure of a rock sample holder of a system for engineering geomechanical experimental testing of a reservoir rock mass disclosed in an embodiment of the present disclosure;

FIG. 8 is a schematic diagram of an exploded structure of a rock sample holder of a system for engineering geomechanical experimental testing of a reservoir rock mass disclosed in an embodiment of the present disclosure;

FIG. 9 is a schematic diagram of a working principle of a multi-phase fluid control unit of a system for engineering geomechanical experimental testing of a reservoir rock mass disclosed in an embodiment of the present disclosure; and

FIG. 10 is a schematic diagram of a working principle of a digital control unit of a system for engineering geomechanical experimental testing of a reservoir rock mass disclosed in an embodiment of the present disclosure.

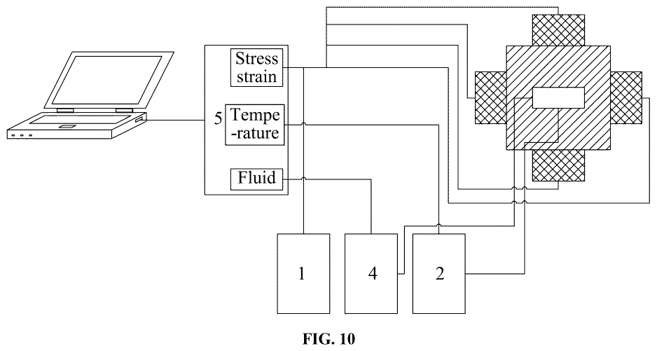

Reference numerals: 1, stress control unit; 101, rigid pressure-applying mechanism; 102, flexible pressure-applying mechanism; 103, pressing piece; 104, indenter; 105, loading driver; 106, motor; 107, oil pump; 108, proportional servo valve; 109, pressure difference balance valve;
2, temperature control unit; 201, outer insulation sleeve; 202, inner insulation sleeve; 203, heating plate;
3, rock sample holder; 301, sealing frame; 302, cooling channel;
4, multi-phase fluid control unit; 401, pump body; 402, intermediate container; 403, multi-way valve; 404, multi-phase fluid channel; and
5, digital control unit.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a system for engineering geomechanical experimental testing of a reservoir rock mass, to resolve the problem in the conventional technology, meet an engineering geomechanical experimental testing need of the reservoir rock mass, and ensure smooth testing.

To make the above objective, features and advantages of the present disclosure clearer and more comprehensible, the present disclosure will be further described in detail below in combination with accompanying drawings and particular implementation modes.

### Embodiment 1

This embodiment provides a system for engineering geomechanical experimental testing of a reservoir rock mass, including a stress control unit 1, a temperature control unit 2, and a rock sample holder 3. The stress control unit 1 includes a rigid pressure-applying mechanism 101 and a flexible pressure-applying mechanism 102. The rigid pressure-applying mechanism 101 includes a pressing piece 103 and an indenter 104. The pressing piece 103 is pressed against a rock mass. The indenter 104 is connected to the pressing piece 103, and the indenter 104 is connected to a loading driver 105. There are six rigid pressure-applying mechanisms 101, the six rigid pressure-applying mechanisms 101 enclose a cuboid structure, and are disposed around the rock mass to apply true triaxial stress to the rock mass. The flexible pressure-applying mechanism 102 includes a pressure-applying cavity, where the pressure-applying cavity is connected to an external pressurized medium source, and the external pressurized medium source is configured to convey a pressure medium into the pressure-applying cavity, to apply flexible pressure to the rock mass. The temperature control unit 2 includes a thermal insulation mechanism, a heating mechanism, and a cooling mechanism. The thermal insulation mechanism includes an inner insulation sleeve 202 and an outer insulation sleeve 201, the inner insulation sleeve 202 is disposed outside the rock mass, and the pressing piece 103 extends through the inner insulation sleeve 202 to press against the rock mass. The outer insulation sleeve 201 is disposed outside the inner insulation sleeve 202 and the pressing piece 103, and the indenter 104 extends through the outer insulation sleeve 201 and is connected to the pressing piece 103. The heating mechanism is configured to heat the rock mass. The cooling mechanism is configured to cool the rock mass. The rock sample holder 3 is of a split-type structure, the rock sample holder 3 is disposed outside the outer insulation sleeve 201 to fasten the stress control unit 1 and the temperature control unit 2, and a space between the rock sample holder 3 and the pressing piece 103 defines the pressure-applying cavity.

According to the system for engineering geomechanical experimental testing of a reservoir rock mass provided in the present disclosure, the stress control unit 1 includes the rigid pressure-applying mechanism 101 and the flexible pressure-applying mechanism 102. The rigid pressure-applying mechanism 101 is configured to apply rigid pressure to the rock mass via the indenter 104 and the pressing piece 103. The flexible pressure-applying mechanism 102 is configured to apply flexible pressure to the rock mass by using the pressure medium. Rigid pressure application and flexible pressure application are integrated in the present disclosure to simulate a stress status under an actual geological condition better, and uniformity of pressure application is also ensured. The temperature control unit 2 is configured to control a temperature of the rock mass via the heating mechanism and the cooling mechanism. In addition, the thermal insulation mechanism is configured to provide double-layer thermal insulation via the inner insulation sleeve 202 and the outer insulation sleeve 201. In this way, a testing temperature condition for the rock mass is kept, and guarantee is provided for testing.

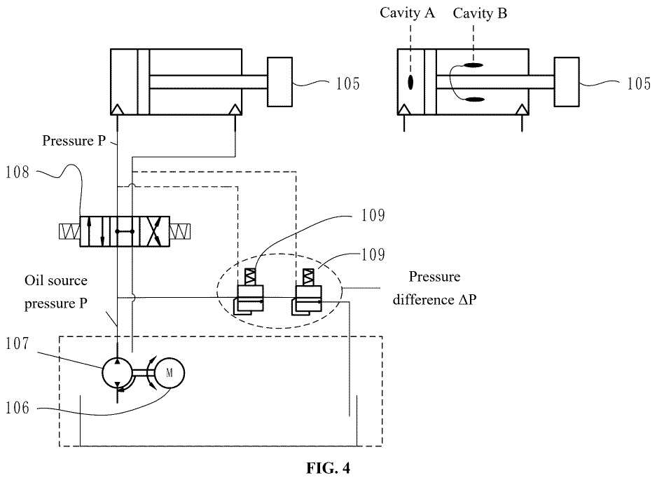

Specifically, the loading driver 105 is a hydraulic oil cylinder, and the loading driver 105 is connected to a servo-hydraulic module. The servo-hydraulic module includes a motor 106, an oil pump 107, and a hydraulic oil tank. For details, refer to FIG. 4. An output end of the motor 106 is in transmission connection to the oil pump 107, the motor 106 is configured to drive the oil pump 107 to rotate, the oil pump 107 is connected to the hydraulic oil tank, the oil pump 107 is connected to the loading driver 105 through a main oil line, the main oil line is further connected to a pilot line, and a pressure difference balance valve 109 is disposed on the pilot line.

The servo-hydraulic module further includes a proportional servo valve 108. The proportional servo valve 108 is mounted on a special valve base. The special valve base is connected to the oil tank through a high-pressure oil tube. The oil pump 107 is separately connected to a cavity A (a piston cavity) and a cavity B (a rod cavity) of the hydraulic oil cylinder via the proportional servo valve 108. A valve element is moved through pilot oil pressure change, achieving control on an overflow amount of the main oil line and ensuring a pressure difference between pressure of the main oil line and the pilot line pressure constant. To be specific, pressure P at an outlet of an oil source is always greater than pressure P1 of the cavity A or the cavity B of the oil cylinder A (P=P1+ΔP, where an adjustable range of ΔP is 0.5 MPa to 2 MPa). Through the servo-hydraulic module, self-adaptive pressure control of a hydraulic loop is ensured by replacing a conventional complex electronic voltage principle with a hydraulic pressure type pressure differential balance principle, and bidirectional pressure intelligent servo drive of the servo-hydraulic module is implemented. A value of oil supply pressure of the servo-hydraulic module is intelligently controlled through load pressure of the oil tank. When the servo-hydraulic module is operated under low pressure, the motor 106 features low energy consumption, low noise, and convenient application without manual adjustment. Therefore, long-period stable loading for the rock mass at a high temperature and a high voltage and under high seepage pressure is implemented. The oil pump 107 is driven by the motor 106 to rotate to convey hydraulic oil into the cavity A and the cavity B of the hydraulic oil cylinder via the high-pressure oil tube and the pressure difference balance valve 109, to drive a piston rod of the hydraulic oil cylinder to extend and retract. For the servo-hydraulic module, refer to FIG. 4.

In a specific implement, the hydraulic oil cylinder sequentially extends through the indenter 104 and the pressing piece 103 to transmit rigid pressure to the rock mass. The pressing piece 103 is made of a high-rigidity insulation material. A locating pin is disposed between the indenter 104 and the pressing piece 103, to uniformly and stably apply pressure. In this way, true triaxial stress is applied to the rock mass in six directions. Herein, it needs to be noted that in actual application, six pressing pieces 103 are linked or separately operated, to meet a loading requirement of testing.

The pressure medium is silicone oil. Flexible pressure is applied to the rock mass by the flexible pressure-applying mechanism 102 by using high-temperature-resistant and high-pressure-resistant silicone oil. In actual application, another loading medium, for example, gas or special liquid, may alternatively be used according to a specific test need, to meet a special test need, thereby ensuring pressure-applying uniformity.

More specifically, the heating mechanism includes a heating plate 203. The heating plate 203 is disposed in the inner insulation sleeve 202 and adjacent to the pressing piece 103. The heating plate 203 is configured to heat the pressure medium and the pressing piece 103 to heat the rock mass. The heating plate 203 may be disposed adjacent to the pressing piece 103, to heat the pressure medium. The pressure medium is filled up in the rock sample holder 3 outside the pressing piece 103. Heat is transferred to the rock mass through the pressure medium and the pressing piece 103, to achieve and keep a specified high-temperature condition for testing.

In a specific implementation, the heating plate 203 has a comb-shaped structure, to increase contact area between the heating plate 203 and the pressure medium, thereby improving heating efficiency and ensuring heating effect.

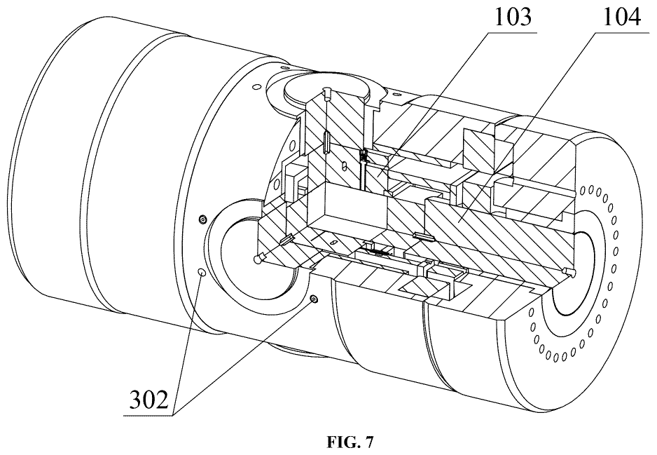

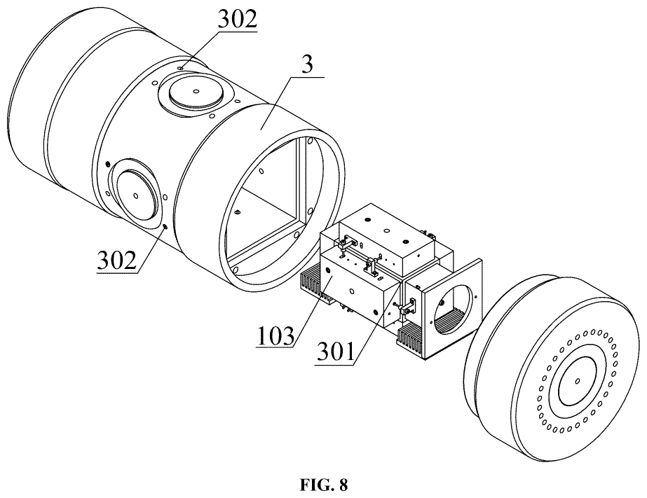

To accurately control a testing temperature by the temperature control unit 2, correspondingly, the cooling mechanism includes cooling channels 302. The cooling channels 302 are disposed inside and outside the rock sample holder 3. The cooling channel 302 is connected to an external cooling medium source, and the external cooling medium source is configured to convey a cooling medium to the cooling channel 302, to cool the rock mass. A quantity and distribution of cooling channels 302 may be adjusted according to an actual test need. In this implementation, eight cooling channels 302 are disposed inside the rock sample holder 3 and outside the rock sample holder 3 to cool the outer insulation sleeve 201, making the thermal insulation mechanism stably operate for a long time in a room-temperature environment. The cooling channel 302 outside the rock sample holder 3 may be implemented by adding a cooling pipeline. For the cooling channel 302 inside the rock sample holder 3, the rock sample holder 3 may be perforated to form the cooling channel 302, or a cooling pipeline is added after the perforating to form the cooling channel 302, thereby facilitating controlling circulation of a cooling medium, as shown in FIG. 7 and FIG. 8. In actual application, a specific structure and a specific loading need of the rock sample holder 3 may be flexibly set to improve adaptive flexibility of the rock sample holder 3. Herein, it needs to be further noted that a mounting position that is matched with the outer insulation sleeve 201 is provided in the rock sample holder 3 to fasten the outer insulation sleeve 201 and then mount the inner insulation sleeve 202, the heating plate 203 and the pressing piece 103, thereby facilitating disassembly and providing convenience for rock mass replacement. The rock sample holder 3 is of a split-type structure, and is convenient to dismount. Both the outer insulation sleeve 201 and the inner insulation sleeve 202 are made of high-temperature-resistant and high-pressure-resistant sheet mica, to ensure working reliability of the thermal insulation mechanism.

It should be further noted that, to facilitate permeability testing, a sealing frame 301 is sleeved outside the rock mass. The sealing frame 301 is of a rectangular frame structure. The pressing piece 103 is pressed against the sealing frame 301, to seal the rock mass in space enclosed by the pressing piece 103, and ensure sealing performance of the rock mass, thereby providing convenience for subsequent permeability testing. When a temperature is lower than 200° C., the sealing frame 301 may be made of a rubber material. When a temperature is higher than 200° C., the sealing frame 301 may be made of a copper material.

To conveniently monitor a testing process, a testing channel is provided in the pressing piece 103 and the indenter 104 to receive a test probe, and a sealing ring is disposed in the testing channel. The sealing ring may integrate polyimide with a carbon fiber material to implement sealing, thereby avoiding reverse seepage of a fluid with high seepage pressure along the testing channel, and guaranteeing smooth testing.

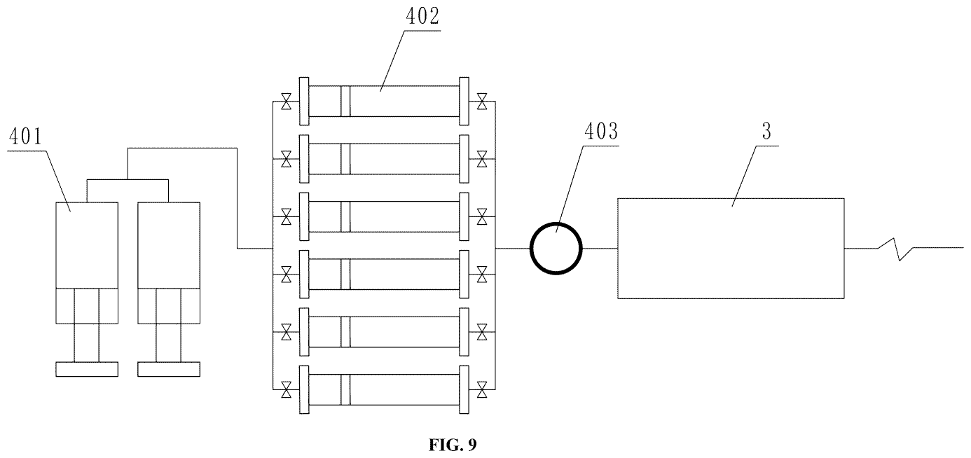

In addition, the system for engineering geomechanical experimental testing of a reservoir rock mass provided in the present disclosure further includes a multi-phase fluid control unit 4. The multi-phase fluid control unit 4 includes an intermediate container 402, a multi-way valve 403, and a multi-phase fluid channel 404. To implement long-period and stable loading simulation of a seepage field, a chemical field, and a biological field, the intermediate container 402 is configured to contain a plurality of fluids. The intermediate container 402 is connected to the rock sample holder 3 through the multi-way valve 403. In addition, the intermediate container 402 is further connected to a pump body 401, making a multi-phase fluid in the intermediate container 402 smoothly enter the rock sample holder 3. In this implementation, there are more than six intermediate containers 402 that may be respectively configured to contain formation water, oil, carbon dioxide and another inert gas in different phase states, a chemical solution and a microbial solution. A valve of a matched intermediate container 402 can be automatically opened according to a testing need, to implement long-period stable loading of different multi-phase fluids. A principle of the multi-phase fluid control unit 4 is as shown in FIG. 9. The pump body 401 may be an ISCO pump, to further improve a controllable degree of the multi-phase fluid control unit 4.

The multi-phase fluid channel 404 is disposed in the pressing piece 103. The multi-phase fluid channel 404 is a T-shaped channel. The multi-phase fluid channel 404 includes an inlet channel, a contact channel, and an outlet channel. The inlet channel is connected to the multi-way valve 403. Both the contact channel and the outlet channel are connected to the inlet channel, an outlet of the contact channel is disposed toward the rock mass, and the outlet channel is connected to an external collecting container. The multi-phase fluid control unit 4 simultaneously meets needs of making the multi-phase fluid flow in or flow out in three main stress directions through sealing and corresponding valve opening or closing operation, thereby eliminating a disadvantage of pipeline dismounting during anisotropic permeability measurement, and alleviating a poor sealing problem caused by a manual operation to a greatest extent.

The system for engineering geomechanical experimental testing of a reservoir rock mass provided in the present disclosure further includes a digital control unit 5. The stress control unit 1, the temperature control unit 2, and the multi-phase fluid control unit 4 are all in communication connection to the digital control unit 5. In actual production, servo closed-loop control under different conditions such as pressure/stress, deformation/stress, temperature and multi-phase fluid may be implemented by the digital control unit 5 based on a software platform, the stress control unit 1, the temperature control unit 2, and the multi-phase fluid control unit 4. Loading condition values such as pressure/stress, deformation/stress, temperature and multi-phase fluid may be dynamically adjusted according to a feedback signal, and testing data is collected and recorded, to ensure stable performing of a multiphase multifield coupling test under preset conditions of high temperature, high pressure, high seepage pressure, multi-ionic coexistence in an acidic/alkaline environment, and a high microbial concentration.

According to the system for engineering geomechanical experimental testing of a reservoir rock mass provided in the present disclosure, rigid pressure-applying and flexible pressure-applying are performed on the rock mass via the rigid pressure-applying mechanism 101, the flexible pressure-applying mechanism 102, and the servo-hydraulic module. The temperature control unit 2 adopts internal heating, external cooling, and dual-layer thermal insulation, and is configured to perform anisotropic permeability measurement via the multi-phase fluid control unit 4, to implement precise high-rigidity loading control for full-process rock mass deformation and instantaneous fracture under a high temperature, high pressure, and high seepage pressure.

### Embodiment 2

This embodiment provides a method for engineering geomechanical experimental testing of a reservoir rock mass, using the system for engineering geomechanical experimental testing of a reservoir rock mass in Embodiment 1, including the following steps.

A rock mass is placed in space enclosed by the six rigid pressure-applying mechanisms 101, rigid pressure is applied by the loading driver 105 to the rock mass via the indenter 104 and the pressing piece 103, and flexible pressure is applied by the flexible pressure-applying mechanism 102 to the rock mass by using a pressure medium.

A temperature is adjusted by the temperature control unit 2 via the heating mechanism and the cooling mechanism, to make the rock mass reach a testing temperature condition, where the thermal insulation mechanism is configured to provide thermal insulation for the rock mass.

The multi-phase fluid control unit 4 is configured to convey different fluids to the multi-phase fluid channel 404, to implement simultaneous measurement of anisotropic permeability of a multi-phase fluid in three main stress directions.

Servo closed-loop control under different conditions such as pressure/stress, deformation/stress, temperature and multi-phase fluid may be implemented by the digital control unit 5 by controlling the stress control unit 1, the temperature control unit 2, and the multi-phase fluid control unit 4. Loading condition values such as pressure/stress, deformation/stress, temperature and multi-phase fluid may be dynamically adjusted according to a feedback signal, and testing data is collected and recorded, to ensure stable performing of a multiphase multifield coupling test under preset conditions of high temperature, high pressure, high seepage pressure, multi-ionic coexistence in an acidic/alkaline environment, and a high microbial concentration.

According to the system and method for engineering geomechanical experimental testing of a reservoir rock mass provided in the present disclosure, a test need of an engineering geomechanical behavior of the reservoir rock mass can be met under a true triaxial loading condition of high temperature, high pressure, and high seepage pressure.

Specific examples are used herein to explain the principles and embodiments of the present disclosure. The foregoing description of the embodiments is merely intended to help understand the method of the present disclosure and its core ideas; besides, various modifications may be made by a person of ordinary skill in the art to specific embodiments and the scope of application in accordance with the ideas of the present disclosure. In conclusion, the content of the specification shall not be construed as limitations to the present disclosure.

What is claimed is:

1. A system for engineering geomechanical experimental testing of a reservoir rock mass, comprising:
a stress control unit, wherein the stress control unit comprises rigid pressure-applying mechanisms and a flexible pressure-applying mechanism, the rigid pressure-applying mechanism comprises a pressing piece and an indenter, the pressing piece is pressed against a rock mass, the indenter is connected to the pressing piece, and the indenter is connected to a loading driver; there are six rigid pressure-applying mechanisms, and the six rigid pressure-applying mechanisms enclose a cuboid structure, and are disposed around the rock mass to apply true triaxial stress to the rock mass; and the flexible pressure-applying mechanism comprises a pressure-applying cavity, wherein the pressure-applying cavity is connected to an external pressurized medium source, and the external pressurized medium source is configured to convey a pressure medium into the pressure-applying cavity, to apply flexible pressure to the rock mass;
a temperature control unit, wherein the temperature control unit comprises a thermal insulation mechanism, a heating mechanism, and a cooling mechanism, the thermal insulation mechanism comprises an inner insulation sleeve and an outer insulation sleeve, the inner insulation sleeve is disposed outside the rock mass, and the pressing piece extends through the inner insulation sleeve to press against the rock mass; and the outer insulation sleeve is disposed outside the inner insulation sleeve and the pressing piece, and the indenter extends through the outer insulation sleeve and is connected to the pressing piece; the heating mechanism is configured to heat the rock mass; and the cooling mechanism is configured to cool the rock mass; and
a rock sample holder, wherein the rock sample holder is of a split-type structure, the rock sample holder is disposed outside the outer insulation sleeve to fasten the stress control unit and the temperature control unit, and a space between the rock sample holder and the pressing piece defines the pressure-applying cavity; wherein
the heating mechanism comprises a heating plate, the heating plate is disposed in the inner insulation sleeve and adjacent to the pressing piece, and the heating plate is configured to heat the pressure medium and the pressing piece to heat the rock mass; and the heating plate has a comb-shaped structure.

2. The system for engineering geomechanical experimental testing of a reservoir rock mass according to claim 1, wherein the loading driver is a hydraulic oil cylinder, the loading driver is connected to a servo-hydraulic module, the servo-hydraulic module comprises a motor, an oil pump, and a hydraulic oil tank, an output end of the motor is in transmission connection to the oil pump, the motor is configured to drive the oil pump to rotate, the oil pump is connected to the hydraulic oil tank, the oil pump is connected to the loading driver through a main oil line, the main oil line is further connected to a pilot line, and a pressure difference balance valve is disposed on the pilot line.

3. The system for engineering geomechanical experimental testing of a reservoir rock mass according to claim 1, wherein the pressure medium is silicone oil.

4. The system for engineering geomechanical experimental testing of a reservoir rock mass according to claim 1, wherein the cooling mechanism comprises cooling channels, the cooling channels are disposed inside and outside the rock sample holder, the cooling channel is connected to an external cooling medium source, and the external cooling medium source is configured to convey a cooling medium to the cooling channel, to cool the rock mass.

5. The system for engineering geomechanical experimental testing of a reservoir rock mass according to claim 1, wherein a sealing frame is sleeved outside the rock mass, the sealing frame is of a rectangular frame structure, and the pressing piece is pressed against the sealing frame to seal the rock mass in space enclosed by the pressing piece; and
a testing channel is provided in each of the pressing piece and the indenter to receive a test probe, a sealing ring is disposed in the testing channel, and a locating pin is disposed between the indenter and the pressing piece.

6. The system for engineering geomechanical experimental testing of a reservoir rock mass according to claim 1, further comprising a multi-phase fluid control unit, wherein the multi-phase fluid control unit comprises an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; the multi-phase fluid channel is disposed in the pressing piece, the multi-phase fluid channel is a T-shaped channel, the multi-phase fluid channel comprises an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

7. The system for engineering geomechanical experimental testing of a reservoir rock mass according to claim 6, further comprising a digital control unit, wherein the stress control unit, the temperature control unit, and the multi-phase fluid control unit are all in communication connection to the digital control unit.

8. The system for engineering geomechanical experimental testing of a reservoir rock mass according to claim 2, further comprising a multi-phase fluid control unit, wherein the multi-phase fluid control unit comprises an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; the multi-phase fluid channel is disposed in the pressing piece, the multi-phase fluid channel is a T-shaped channel, the multi-phase fluid channel comprises an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

9. The system for engineering geomechanical experimental testing of a reservoir rock mass according to claim 3, further comprising a multi-phase fluid control unit, wherein the multi-phase fluid control unit comprises an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; the multi-phase fluid channel is disposed in the pressing piece, the multi-phase fluid channel is a T-shaped channel, the multi-phase fluid channel comprises an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

10. The system for engineering geomechanical experimental testing of a reservoir rock mass according to claim 4, further comprising a multi-phase fluid control unit, wherein the multi-phase fluid control unit comprises an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; the multi-phase fluid channel is disposed in the pressing piece, the multi-phase fluid channel is a T-shaped channel, the multi-phase fluid channel comprises an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

11. The system for engineering geomechanical experimental testing of a reservoir rock mass according to claim 5, further comprising a multi-phase fluid control unit, wherein the multi-phase fluid control unit comprises an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; the multi-phase fluid channel is disposed in the pressing piece, the multi-phase fluid channel is a T-shaped channel, the multi-phase fluid channel comprises an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

12. A method for engineering geomechanical experimental testing of a reservoir rock mass, using the system for engineering geomechanical experimental testing of a reservoir rock mass according to claim 1, comprising the following steps:
placing a rock mass in space enclosed by the six rigid pressure-applying mechanisms, applying rigid pressure, by the loading driver, to the rock mass via the indenter and the pressing piece, and applying, by the flexible pressure-applying mechanism, flexible pressure to the rock mass by using a pressure medium; and
adjusting a temperature, by the temperature control unit, via the heating mechanism and the cooling mechanism, to make the rock mass reach a testing temperature condition, wherein the thermal insulation mechanism is configured to provide thermal insulation for the rock mass.

13. The method for engineering geomechanical experimental testing of a reservoir rock mass according to claim 12, wherein the loading driver is a hydraulic oil cylinder, the loading driver is connected to a servo-hydraulic module, the servo-hydraulic module comprises a motor, an oil pump, and a hydraulic oil tank, an output end of the motor is in transmission connection to the oil pump, the motor is configured to drive the oil pump to rotate, the oil pump is connected to the hydraulic oil tank, the oil pump is connected to the loading driver through a main oil line, the main oil line is further connected to a pilot line, and a pressure difference balance valve is disposed on the pilot line.

14. The method for engineering geomechanical experimental testing of a reservoir rock mass according to claim 12, wherein the pressure medium is silicone oil.

15. The method for engineering geomechanical experimental testing of a reservoir rock mass according to claim 12, wherein the cooling mechanism comprises cooling channels, the cooling channels are disposed inside and outside the rock sample holder, the cooling channel is connected to an external cooling medium source, and the external cooling medium source is configured to convey a cooling medium to the cooling channel, to cool the rock mass.

16. The method for engineering geomechanical experimental testing of a reservoir rock mass according to claim 12, wherein a sealing frame is sleeved outside the rock mass, the sealing frame is of a rectangular frame structure, and the pressing piece is pressed against the sealing frame to seal the rock mass in space enclosed by the pressing piece; and
a testing channel is provided in each of the pressing piece and the indenter to receive a test probe, a sealing ring is disposed in the testing channel, and a locating pin is disposed between the indenter and the pressing piece.

17. The method for engineering geomechanical experimental testing of a reservoir rock mass according to claim 12, further comprising a multi-phase fluid control unit, wherein the multi-phase fluid control unit comprises an intermediate container, a multi-way valve, and a multi-phase fluid channel, the intermediate container is configured to contain a plurality of fluids, the intermediate container is connected to the rock sample holder through the multi-way valve, and the intermediate container is further connected to a pump body; the multi-phase fluid channel is disposed in the pressing piece, the multi-phase fluid channel is a T-shaped channel, the multi-phase fluid channel comprises an inlet channel, a contact channel, and an outlet channel, the inlet channel is connected to the multi-way valve, both the contact channel and the outlet channel are connected to the inlet channel, an outlet of the contact channel is disposed toward the rock mass, and the outlet channel is connected to an external collecting container.

18. The method for engineering geomechanical experimental testing of a reservoir rock mass according to claim 17, further comprising a digital control unit, wherein the stress control unit, the temperature control unit, and the multi-phase fluid control unit are all in communication connection to the digital control unit.
